(19) United States
(12) Patent Application Publication
(10) Pub. No.: US 2024/0203135 A1
(43) Pub. Date: Jun. 20, 2024

(54) AUTONOMOUS DRIVING USING SEMANTIC INFORMATION OF A ROAD

(71) Applicant: TuSimple, Inc., SAN DIEGO, CA (US)

(72) Inventors: Yizhe ZHAO, San Diego, CA (US); Lingting GE, San Diego, CA (US); Panqu WANG, San Diego, CA (US)

(21) Appl. No.: 18/474,812

(22) Filed: Sep. 26, 2023

Related U.S. Application Data
(60) Provisional application No. 63/387,579, filed on Dec. 15, 2022.

(51) Int. Cl. G06V 20/56; B60W 60/00; G06T 7/12; G06T 7/73; G06T 15/00; G06V 20/70; G08G 1/16

(52) U.S. Cl. CPC G06V 20/588; B60W 60/001; G06T 7/12; G06T 7/74; G06T 15/00; G06V 20/70; G08G 1/167; B60W 2420/42; B60W 2520/10; B60W 2552/10; B60W 2552/15; B60W 2555/60; B60W 2556/40; B60W 2710/18; B60W 2710/20; G06T 2207/30256

(57) ABSTRACT

Techniques are described for autonomous driving operation that includes receiving, by a computer located in a vehicle, an image from a camera located on the vehicle while the vehicle is operating on a road, wherein the image includes a plurality of lanes of the road; for each of the plurality of lanes: obtaining, from a map database stored in the computer, a set of values that describe locations of boundaries of a lane; dividing the lane into a plurality of polygons; rendering the plurality of polygons onto the image; and determining identifiers of lane segments of the lane; determining one or more characteristics of a lane segment on which the vehicle is operating based on an identifier of the lane segment; and causing the vehicle to perform a driving related operation in response to the one or more characteristics of the lane segment on which the vehicle is operating.

### CROSS-REFERENCE TO RELATED APPLICATIONS

This patent application claims priority to and the benefit of U.S. Provisional Application No. 63/387,579, filed on Dec. 15, 2022. The aforementioned application is incorporated herein by reference in its entirety.

### TECHNICAL FIELD

This document relates to systems, apparatus, and methods to render and/or use semantic information of a road for autonomous driving operation(s).

### BACKGROUND

Autonomous vehicle navigation is a technology that can allow a vehicle to sense the position and movement of vehicles around an autonomous vehicle and, based on the sensing, control the autonomous vehicle to safely navigate towards a destination. An autonomous vehicle may operate in several modes. In some cases, an autonomous vehicle may allow a driver to operate the autonomous vehicle as a conventional vehicle by controlling the steering, throttle, clutch, gear shifter, and/or other devices. In other cases, a driver may engage the autonomous vehicle navigation technology to allow the vehicle to be driven by itself. In yet some other cases, an autonomous vehicle may be driven without a driver from a starting location to a destination.

### SUMMARY

A computer located in an autonomous vehicle can perform computations to render and/or use semantic information of a road using an image obtained from a camera and map information related to a location of the vehicle. In some embodiments where object(s) and/or vehicle(s) are operating or located around the autonomous vehicle, the computer can determine one or more lane segments on which the object(s) and/or the vehicle(s) are located or operating so that the computer can assign each object and/or vehicle with a set of one or more identifiers associated with the one or more lane segments.

An example method of driving operation includes receiving, by a computer located in a vehicle, an image from a camera located on the vehicle while the vehicle is operating on a road, where the image includes a plurality of lanes of the road; for each of the plurality of lanes: obtaining, from a map database stored in the computer, a set of values that describe locations of boundaries of a lane; dividing the lane into a plurality of polygons, where each polygon has vertices located at the boundaries of the lane, where the vertices are associated with location values from the set of values; rendering the plurality of polygons onto the image; and determining identifiers of lane segments of the lane, where the lane segments are imaginary and extend lengthwise along the lane, and where at least one lane segment of the lane is adjacent to at least one other lane segment of the lane; determining one or more characteristics of a lane segment on which the vehicle is operating based on an identifier of the lane segment; and causing the vehicle to perform a driving related operation in response to the one or more characteristics of the lane segment on which the vehicle is operating.

In some embodiments, the method further comprises performing a first determination that a first polygon on the lane in the image has at least some region that overlaps with at least some other region of a second polygon on the lane in the image, where the first polygon includes a first set of sub-regions, and where the second polygon includes a second set of sub-regions; and obtaining, in response to the first determination, a third polygon as a combination of the first polygon and the second polygon by including in the third polygon a third set of sub-regions from the first set of sub-regions or the second set of sub-regions by comparing depth values of each overlapping sub-region from the first set of sub-regions and the second set of sub-regions. In some embodiments, each sub-region in the first set of sub-regions and the second set of sub-regions is associated with a depth value that describes a distance between a sub-region and a location of the vehicle. In some embodiments, the third polygon includes one or more non-overlapping regions from the first polygon and the second polygon. In some embodiments, for each overlapping sub-regions from the first set of sub-regions and the second set of sub-regions, the third set of sub-regions includes a first sub-region associated with a depth value that is closer to a location of the vehicle than that of a second sub-region that overlaps with the first sub-region.

In some embodiments, for each of the plurality of lanes, a plurality of pixels within the boundaries of the lane are associated with the identifiers of the lane segments of the lane. In some embodiments, a pixel value of a pixel from the plurality of pixels stores a second identifier of one lane segment that comprises the pixel. In some embodiments, for each of the plurality of lanes, the plurality of polygons includes a plurality of triangles that are located adjacent to each other and that describe an extent of the lane. In some embodiments, the set of values that describe the locations of the boundaries of the lane includes three-dimensional (3D) world coordinates for each of a plurality of point along the boundaries of the lane. In some embodiments, a plurality of pixels within the boundaries of the lane are associated with the 3D world coordinates of the lane.

In some embodiments, the one or more characteristics are determined by the processor configured to query the map database using the identifier of the lane segment, and the one or more characteristics includes a speed limit of the lane segment, an uphill grade of the lane segment, a downhill grade of the lane segment, or a description of a type of the lane segment. In some embodiments, the identifiers of the lane segments for each of the plurality of lanes are different from each other. In some embodiments, the one or more characteristics of the lane segment on which the vehicle is operating includes a speed limit of the lane segment, and the vehicle is caused to perform the driving related operation by the processor configured to: determine that a speed of the vehicle is greater than the speed limit of the lane segment; and send, to one or more motors of a brake pedal or one or more actuators associated with brakes of the vehicle, instruction that cause brakes to be applied.

In some embodiments, for each of the plurality of lanes, the identifiers of the lane segments of the lane is determined by: obtaining a location of the vehicle; and determining, from the map database stored in the computer, the identifiers of the lane segments of the lane located in front of or around the location of the vehicle. In some embodiments, the method further comprises: assigning, for each of the plurality of lanes, the identifiers of the lane segments of the lane to the lane segments on the lane in the image by determining in image locations of the lane segments relative to the location of the vehicle. In some embodiments, the method further comprises: assigning at least one identifier of a first lane segment to at least one vehicle in response to determining that the at least one vehicle is operating or located on the first lane segment.

In some embodiments, the causing the vehicle to perform the driving related operation includes sending an instruction to a motor associated with a steering system of the vehicle that causes the vehicle to move into another lane adjacent to the lane and away from an emergency lane in response to determining that: (1) the at least one identifier assigned to the at least one vehicle is associated with the emergency lane, and (2) the vehicle is operating on the lane immediately adjacent to the emergency lane. In some embodiments, the determining the identifiers of the lane segments of the lane located around the vehicle includes determining the identifiers of the lane segments of the lane located within a pre-determined distance from the location of the vehicle.

In yet another exemplary aspect, the above-described method is embodied in a non-transitory computer readable storage medium comprising code that when executed by a processor, causes the processor to perform the methods described in this patent document.

In yet another exemplary embodiment, a device that is configured or operable to perform the above-described methods is disclosed. In yet another exemplary embodiment, a system that includes a computer with a processor configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a block diagram of an example vehicle ecosystem in which an in-vehicle control computer located in the vehicle can render and/or use semantic information for autonomous driving operations.

FIG. 2A shows an example flowchart of assigning one or more identifiers to object(s) and/or vehicle(s) located around an autonomous vehicle and rendering lane segments of a lane where a lane segment is being occluded by another lane segment.

FIG. 2B shows an example scenario where an image obtained by a camera comprises a lane that includes a first polygon having at least some region that overlaps with at least some other region of a second polygon on the lane in the image.

FIG. 3 shows a triangulation process on an image of a road surface.

FIG. 4 shows an example flowchart of causing a vehicle to operate on a road in accordance with or in response to one or more characteristics of a lane segment on a lane on which the vehicle is operating.

### DETAILED DESCRIPTION

Autonomous driving technology can allow a vehicle to be operated along a trajectory along a trajectory from a starting point to a destination by sending driving related instructions to one or more devices in the autonomous vehicle (e.g., steering system motor, brake motor, engine, etc.). As the autonomous vehicle is driven along the trajectory, the autonomous vehicle is also expected to drive safely around object(s) and/or vehicle(s) that are located or operating around the autonomous vehicle on a road. Thus, one of the techniques described in this patent document is for a computer located in the autonomous vehicle to determine one or more lane segments on which the object(s) and/or the vehicle(s) are located or operating so that the computer can assign each object and/or vehicle with a set of one or more identifiers associated with the one or more lane segments.

The assigned set of one or more identifiers for each object and/or vehicle can be a beneficial technical feature that can allow the computer in the autonomous vehicle to filter out object(s) and/or vehicle(s) that are not as important to the driving related operations of the autonomous vehicle. The object(s) and/or vehicle(s) that are located or operating on different parts of the road can be associated with different levels of importance with respect to the driving related operations of the autonomous vehicle. For example, if an autonomous vehicle is operating in a forward direction, then an object or vehicle located to the rear of the autonomous vehicle can have a potential to impact driving related operations of the autonomous vehicle that is less than that of another object or another vehicle located to the front of the autonomous vehicle. In another example, if a car is parked on the emergency lane located in front of the autonomous vehicle or is driving on a merge-in ramp to the front of the autonomous vehicle, then that car can be considered important to the driving related operations of the autonomous vehicle. Thus, using the set of one or more identifiers associated with an object and/or vehicle, the computer can filter out those object(s) and/or vehicle(s) that may not affect the driving related operations of the autonomous vehicle, and the computer can perform further computations on the remaining object(s) and/or vehicle(s) that the computer considers is/are important to the driving operation of the autonomous vehicle. Thus, one of the technical benefits of the described technology is that it can preserve computational resources by filtering out object(s) and/or vehicle(s) that are not important to the driving related operations of the autonomous vehicle.

Section I provides an overview of the devices/systems located on or in an autonomous vehicle, such as an autonomous semi-trailer truck. Section II of this patent document describes some current techniques and their drawbacks. Section III of this patent document describes techniques for performing computations to render semantic information of a road and techniques for performing autonomous driving operation using the semantic information of the road. The example technology described in Section III describe techniques that can overcome at least the technical drawbacks described in Section II. The example headings for the various sections below are used to facilitate the understanding of the disclosed subject matter and do not limit the scope of the claimed subject matter in any way. Accordingly, one or more features of one example section can be combined with one or more features of another example section.

### II. Autonomous Driving Ecosystem

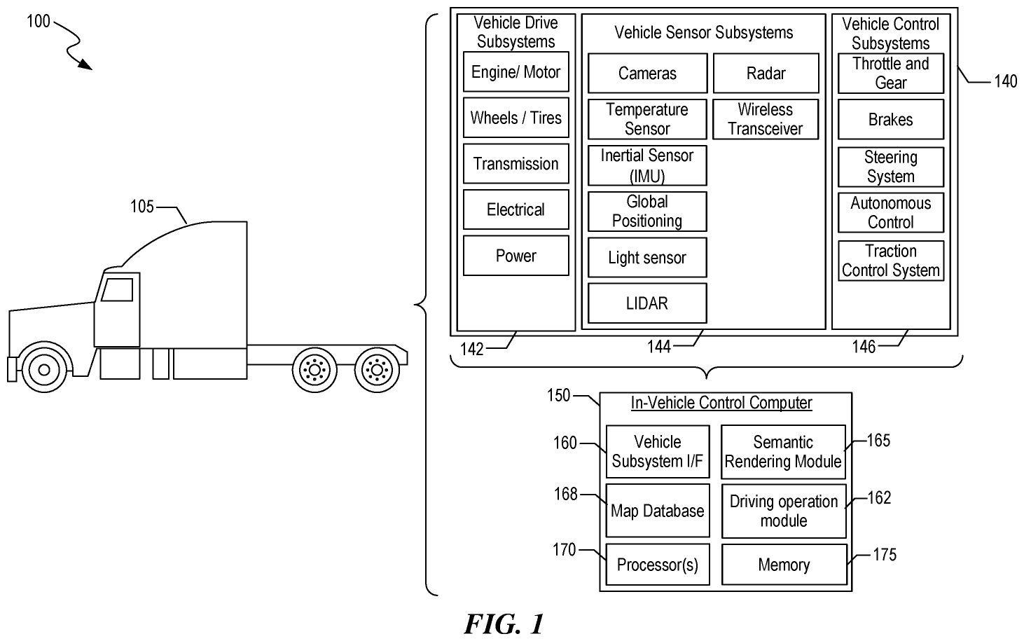

FIG. 1 shows a block diagram of an example vehicle ecosystem 100 in which an in-vehicle control computer 150 located in the vehicle 105 can render and/or use semantic information for autonomous driving operations. As shown in FIG. 1, the vehicle 105 may be a semi-trailer truck. The vehicle ecosystem 100 includes several systems and components that can generate and/or deliver one or more sources of information/data and related services to the in-vehicle control computer 150 that may be located in a vehicle 105. The in-vehicle control computer 150 can be in data communication with a plurality of vehicle subsystems 140, all of which can be resident in the vehicle 105. A vehicle subsystem interface 160 is provided to facilitate data communication between the in-vehicle control computer 150 and the plurality of vehicle subsystems 140. In some embodiments, the vehicle subsystem interface 160 can include a controller area network (CAN) controller to communicate with devices in the vehicle subsystems 140.

The vehicle 105 may include various vehicle subsystems that support of the operation of vehicle 105. The vehicle subsystems may include a vehicle drive subsystem 142, a vehicle sensor subsystem 144, and/or a vehicle control subsystem 146. The components or devices of the vehicle drive subsystem 142, the vehicle sensor subsystem 144, and the vehicle control subsystem 146 as shown as examples. In some embodiment, additional components or devices can be added to the various subsystems or one or more components or devices can be removed without affecting the techniques to render and/or use semantic information for autonomous driving operations as described in this patent document. The vehicle drive subsystem 142 may include components operable to provide powered motion for the vehicle 105. In an example embodiment, the vehicle drive subsystem 142 may include an engine or motor, wheels/tires, a transmission, an electrical subsystem, and/or a power source.

The vehicle sensor subsystem 144 may include a number of sensors configured to sense information about an environment in which the vehicle 105 is operating or a condition of the vehicle 105. As further explained in this patent document, the semantic rendering module 165 and the driving operation module 162 in the in-vehicle control computer 150 can use the information provided by the camera(s) and/or map information from map database 168 stored in the in-vehicle control computer 150 to render and/or use semantic information for autonomous driving operations.

The vehicle sensor subsystem 144 may include one or more cameras or image capture devices, one or more temperature sensors, an inertial measurement unit (IMU), a Global Positioning System (GPS) transceiver, a laser range finder/LiDAR unit, a Radar unit, and/or a wireless transceiver (e.g., a cellular communication transceiver). The vehicle sensor subsystem 144 may also include sensors configured to monitor internal systems of the vehicle 105 (e.g., an O₂ monitor, a fuel gauge, an engine oil temperature, etc.). In some embodiments, the vehicle sensor subsystem 144 may include sensors in addition to the sensors shown in FIG. 1.

The IMU may include any combination of sensors (e.g., accelerometers and gyroscopes) configured to sense position and orientation changes of the vehicle 105 based on inertial acceleration. The GPS transceiver may be any sensor configured to estimate a geographic location of the vehicle 105. For this purpose, the GPS transceiver may include a receiver/transmitter operable to provide information regarding the position of the vehicle 105 with respect to the Earth. The Radar unit may represent a system that utilizes radio signals to sense objects within the environment in which the vehicle 105 is operating. In some embodiments, in addition to sensing the objects, the Radar unit may additionally be configured to sense the speed and the heading of the objects proximate to the vehicle 105. The laser range finder or LiDAR unit may be any sensor configured to sense objects in the environment in which the vehicle 105 is located using lasers. The cameras may include one or more cameras configured to capture a plurality of images of the environment of the vehicle 105. The cameras may be still image cameras or motion video cameras.

The vehicle control subsystem 146 may be configured to control operation of the vehicle 105 and its components. Accordingly, the vehicle control subsystem 146 may include various elements such as a throttle and gear, a brake unit, a steering system and/or an autonomous control unit. The throttle may be configured to control, for instance, the operating speed of the engine and, in turn, control the speed of the vehicle 105. The gear may be configured to control the gear selection of the transmission. The brake unit can include any combination of mechanisms configured to decelerate the vehicle 105. The brake unit can use friction to slow the wheels in a standard manner. The brake unit may include an anti-lock brake system (ABS) that can prevent the brakes from locking up when the brakes are applied. The steering system may represent any combination of mechanisms that may be operable to adjust the heading of vehicle 105 in an autonomous mode or in a driver-controlled mode.

The autonomous control unit may represent a control system configured to identify, evaluate, and avoid or otherwise negotiate potential obstacles in the environment of the vehicle 105. In general, the autonomous control unit may be configured to control the vehicle 105 for operation without a driver or to provide driver assistance in controlling the vehicle 105. In some embodiments, the autonomous control unit may be configured to incorporate data from the GPS transceiver, the Radar, the LiDAR, the cameras, and/or other vehicle subsystems to determine the driving path or trajectory for the vehicle 105.

The traction control system (TCS) may represent a control system configured to prevent the vehicle 105 from swerving or losing control while on the road. For example, TCS may obtain signals from the IMU and the engine torque value to determine whether it should intervene and send instruction to one or more brakes on the vehicle 105 to mitigate the vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

Many or all of the functions of the vehicle 105 can be controlled by the in-vehicle control computer 150. The in-vehicle control computer 150 may include at least one processor 170 (which can include at least one microprocessor) that executes processing instructions stored in a non-transitory computer readable medium, such as the memory 175. The in-vehicle control computer 150 may also represent a plurality of computing devices that may serve to control individual components or subsystems of the vehicle 105 in a distributed fashion. In some embodiments, the memory 175 may contain processing instructions (e.g., program logic) executable by the processor 170 to perform various methods and/or functions of the vehicle 105, including those described for the semantic rendering module 165 and for the driving operation module 162 as explained in Section III of this patent document.

The memory 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 may control the function of the vehicle 105 based on inputs received from various vehicle subsystems (e.g., the vehicle drive subsystem 142, the vehicle sensor subsystem 144, and the vehicle control subsystem 146).

### II. Current Technology

Current technology for associating a vehicle with a lane uses the three-dimensional (3D) location of the vehicle to determine a part of the road on which the vehicle is located. Due to the limited perception range of LiDAR sensors, 3D location estimation on distant object(s) and/or vehicle(s) relies on image-based approaches. However, image-based 3D location estimation usually has a large error ratio and does not provide an accurate enough prediction related to whether an object or vehicle is on multiple lanes. A small deviation in 3D position can lead to different lane assignments so that this technique can fail in practice and can lead to unsafe driving related operations of the autonomous vehicle with respect to the vehicle.

Another current technology for associating a vehicle with a lane can take boundary information of each lane segment from a map and project it on a two-dimensional (2D) image as a polygon. In this technique, the algorithm can then check the relationships between the polygon and 2D bounding box results located around a vehicle. However, this technique does not handle well circumstances where part of the road surface will be occluded by some other part of the road surface (e.g., a part of a road located further away from an autonomous vehicle is occluded by a hill towards which the autonomous vehicle is driving). In such circumstances where the road is not flat, multiple lanes (lanes in front of and behind the hill in the example above) are projected to the same position on the image causing an algorithm failure and/or an unsafe driving operation of the autonomous vehicle.

### III. Example Techniques for Performing Autonomous Driving Operation Using Rendered Semantic Information of a Road

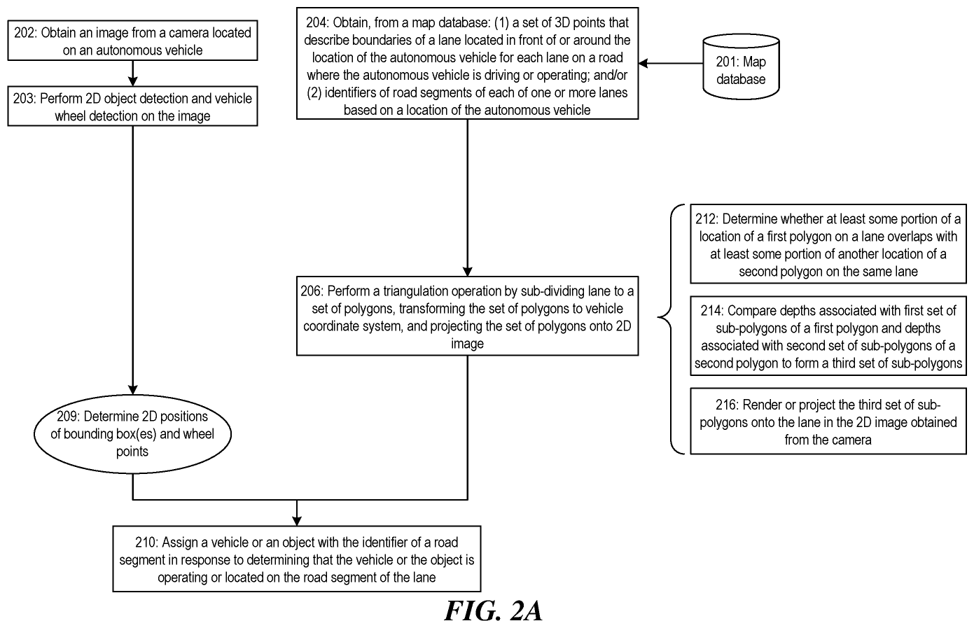

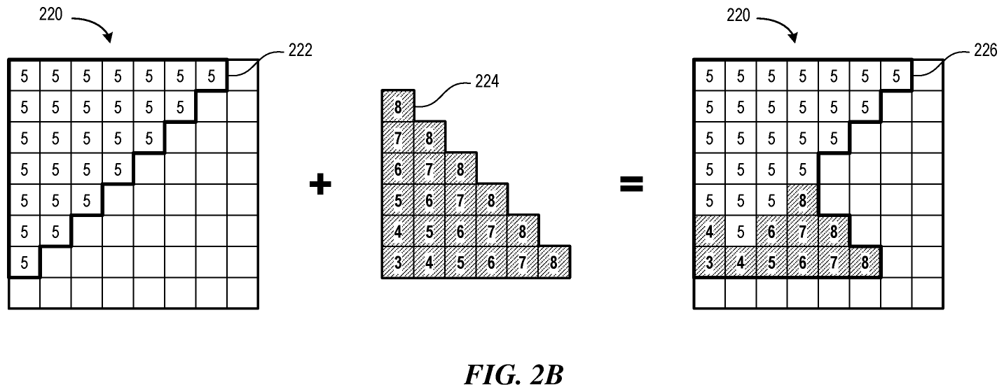

FIG. 2A shows an example flowchart of assigning one or more identifiers to object(s) and/or vehicle(s) located around an autonomous vehicle and rendering lane segments of a lane where a lane segment is being occluded by another lane segment. The operations shown in FIG. 2A may be performed as the autonomous vehicle is being driven on a road. At operation 202, the semantic rendering module obtains an image from a camera located on an autonomous vehicle. At operation 203, the semantic rendering module can perform image processing techniques to detect a 2D object (e.g., a vehicle), detect wheel(s) of the vehicle(s), and add bounding box(es) around the detected vehicle(s). At operation 209, the semantic rendering module can determine 2D position(s) of the bounding box(es) and wheel points of the vehicle(s).

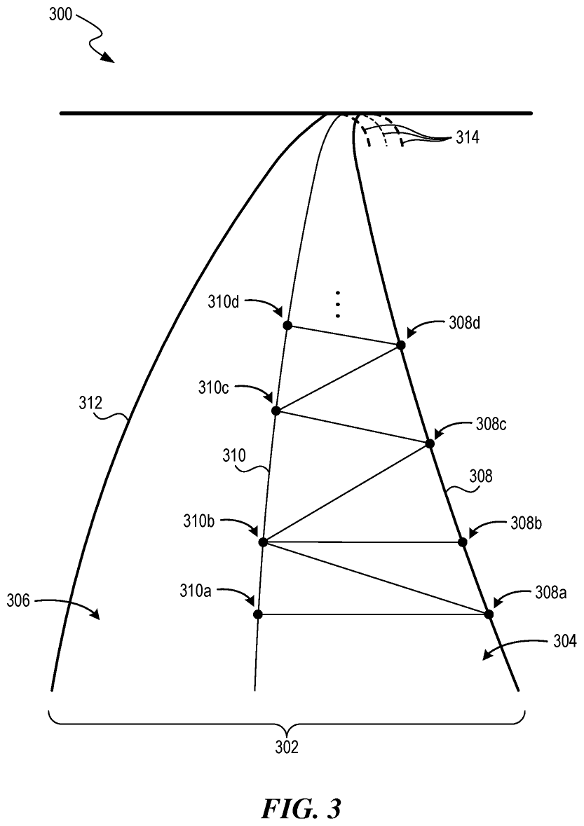

At operation 204, the semantic rendering module can obtain a location of the autonomous vehicle from a localization device (e.g., a GPS transceiver) on the autonomous vehicle and access the map database 201 (also 168 in FIG. 1) to obtain a set of 3D points that describe locations of boundaries of a lane located in front of or around the location of the autonomous vehicle for each lane on a road where the autonomous vehicle is driving or operating. The set of 3D points may describe location values in 3D world coordinates for each point of a plurality of points along the boundaries (e.g., shown as 308 and 310 in FIG. 3) of the lane. In some embodiments, the set of 3D points are associated with boundaries of a lane on one side of the road where the autonomous vehicle is operating or driving and not on the other side of the road where other vehicles are operating or driving in an opposite direction.

At operation 204, the semantic rendering module can also obtain from the map database identifiers of lane segments for each of one or more lanes located around the autonomous vehicle based on a location of the autonomous vehicle. A lane of a road may be conceptually broken up into a plurality of lane segments, where each lane segment can extend lengthwise along the road and can have a pre-determined length (e.g., 250 meters), and where a first lane segment of the lane is adjacent to a second lane segment of the lane, and so on. The lane segments of a lane are imaginary where each lane segment can be used to identify a distinct portion or region or area of the lane. Location of the autonomous vehicle can be obtained from a localization device such as a GPS device. Information about identifiers corresponding to each lane segment of a lane for each lane on a road is stored in the map database (168 in FIG. 1). Thus, for example, the semantic rendering module can obtain identifiers of the lane segments of the lanes within a pre-determined distance from the location of the autonomous vehicle.

After the semantic rendering module obtains a set of 3D points that describe boundaries of a lane for each lane of a road where the autonomous vehicle is driving or operating, the semantic rendering module performs operation 206 by performing a triangulation operation where the lane surface is subdivided to a set of polygons (e.g., triangles) whose vertices are from 3D points of boundaries of lanes, and a rendering operation where the set of polygons are transformed from 3D space to vehicle coordinate system (e.g., using current localization technology) and then are projected or rendered (e.g., drawn) onto the 2D image. A process of rendering 3D polygons on 2D image can be done with existing rendering pipeline technology. At operation 206, pixels within lane boundaries can be associated with a 3D location information and can be associated with a vertex of a triangle as further explained in FIG. 3.

FIG. 3 shows a triangulation process on an image 300 of a road 302 that includes two lanes 204, 306 that have an uphill slope followed by a downhill slope. The first lane 304 includes two lane boundaries 308 and 310, and the second lane 306 includes two lane boundaries 310 and 312. One or more vehicles operating on lane 304 or 306 is expected to operate within the two lane boundaries associated with that lane with the exception of certain driving operations such as making lane changes or merging into a lane. In FIG. 3, the two lanes are shown as extending uphill towards the horizon after which the lanes are not shown by the image. The dotted lines 314 indicate the location of the boundaries of the lanes past the horizon.

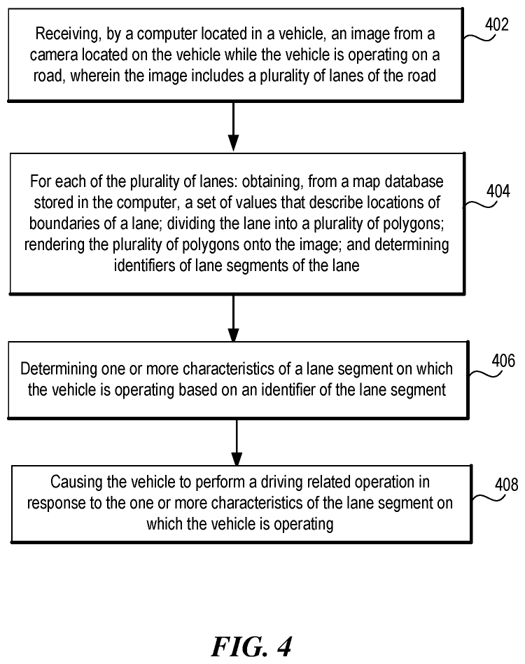

As mentioned above in operation 206 in FIG. 2A, the semantic rendering module performs a triangulation operation by subdividing a lane to a set of polygons, transforming the set of polygons to vehicle coordinate system and projecting or rendering the set of polygons onto the 2D image. For ease of explanation the triangulation process is explained for lane 304 that shows at least some of the 3D points 308a-308d and 310a-310d that describe 3D points along boundaries of lane 304. Triangulation process can be performed on multiple lanes (e.g., lanes 304, 306) using the technique described for lane 304. At operation 206, the semantic rendering module can connect at least some of the 3D points 308a-308d and 310a-310d to have a plurality of polygons (e.g., triangles shown in FIG. 3) that define an area associated with the lane 304. For example, 3D points 310a, 310b and 308a can be connected to form a triangle, 3D points 310b, 308a, and 308b can be connected to form another triangle and so on. The semantic rendering module in operation 206 in FIG. 2A can also perform a 3D polygon rendering process where the set of polygons can be rendered onto the 2D image by going through a 3D rendering pipeline technology. In some embodiments, the semantic rendering module can color or shade or render the polygons (or triangles in FIG. 3) associated with a same lane for each of one or more lanes on the road. In some embodiments where a road includes multiple lanes, the semantic rendering module can color or shade or render the polygons on one lane differently than the color or shading or render on another lane. In some embodiments, the pixels within the lane boundaries can store a lane identifier of a lane segment of the lane. One of the technical benefits of the disclosed technology is that the results obtained by operations in FIGS. 2A and 4 are more accurate than using 3D location estimation at least because 2D detection accuracy is better than 3D detection.

In FIG. 2A, performing operation 206 may include performing operations 212-216 for scenarios where at least some region of a polygon overlaps with at least some region of another polygon. The semantic rendering module performs operation 212 where the semantic rendering module determines whether at least some portion of a location of a first polygon (e.g., a first triangle) on a lane overlaps in 2D image with at least some portion of another location of a second polygon (e.g., a second triangle) on the same or a different lane. If the semantic rendering module determines that at least some portion of the location of a first polygon on a lane overlaps in 2D image with at least some portion of another location of the second polygon on the same or a different lane, then the semantic rendering module determines or obtains depths of a plurality of sub-polygons within each of the first polygon and second polygon as shown in FIG. 2B, where the depths are determined relative to the location of the autonomous vehicle so that the depths can be considered distances between the autonomous vehicles and the plurality of sub-polygons within each of the first polygon and the second polygon. In some embodiments, the depths of the plurality of sub-polygons within the first polygon and the second polygon can be obtained using 3D positions of polygon vertices from the map database and world-to-vehicle transformation matrices from the localization device.

FIG. 2B shows a set of pixels 220 where locations of a first set of sub-polygons (shown with square blocks) within a first polygon 222 overlap with locations of a second set of sub-polygons (shown with square blocks) within a second polygon 224. At operation 214, the semantic rendering module can compare depths associated with the first set of sub-polygons of the first polygon 222 and depths associated with the second set of sub-polygons of the second polygon 224 to form a third set of sub-polygons. Thus, at operation 214, depths of the sub-polygons between two sets are compared to determine a set of sub-polygons that are closer to the autonomous vehicle (e.g., front-most ones) that should be displayed on the image. In FIG. 2B, the depths are indicated by numbers within the two sub-polygons, where the higher the number, the farther the location of the sub-polygon relative to the location of the autonomous vehicle. The third set of sub-polygons include one or more non-overlapping sub-polygons from the first and second set of sub-polygons (e.g., the one or more non-overlapping sub-polygons from 222 and 224 are included in 226). The third set of sub-polygons also include a set of one or more sub-polygons associated with a depth value that is closer to the location of the autonomous vehicle than that of another set of one or more sub-polygons that overlap with the set of one or more sub-polygons (e.g., for two overlapping sub-polygons from 222 and 224, a sub-polygon associated with a smaller depth value is included in 226 in the set of pixels 220). At operation 216, the semantic rendering module can render or project the third set of sub-polygons (226 in FIG. 2B) onto the lane in the 2D image obtained from the camera. At operation 216, the third set of sub-polygons can be projected or drawn on the image and the identifiers of the lane segments of the lane can also be added to the image. Thus, the technique described in FIGS. 2A-2B can allow the in-vehicle control computer in the autonomous vehicle to avoid projecting farther portions of lane segment(s) that are occluded by nearer portions of lane segment(s), where the lane segment(s) are farther or nearer relative to a location of the autonomous vehicle. Thus, the technique described in FIGS. 2A and 2B can avoid the situation described in Section II where multiple lanes are projected or rendered to the same position on the image, which can cause an algorithm failure and/or an unsafe driving operation of the autonomous vehicle.

In FIG. 2A, at operation 210, the semantic rendering module can assign a vehicle or an object with an identifier of a lane segment of a lane in response to determining that the vehicle or the object is operating or located on the lane segment of the lane in the 2D image. As mentioned above, in some embodiments, the pixels within the lane boundaries can store a lane identifier of a lane segment of the lane. Thus, for example, at operations 210, the semantic rendering module can assign a first car with a first identifier (e.g., “lane-1”) and can assign a second car with a second identifier (e.g., “lane-2”) upon determining from the 2D image that the first car is operating on a first lane segment associated with the first identifier and that the second car is operating on a second lane segment associated with the second identifier. In this example, the semantic rendering module can search the identifier(s) in the map database to determine that “lane-1” is an identifier associated with a lane segment that includes a merge-in ramp, and that “lane-2” is an identifier associated with a lane segment of a lane that has traffic that moves in an opposite direction than a direction of the trajectory of the autonomous vehicle. In some embodiments, the semantic rendering module can avoid performing intensive or additional image processing or signal processing on vehicle(s) associated with the lane-2 identifier, and the semantic rendering module can further perform additional image processing or signal processing on the vehicle(s) associated with lane-1 identifier in response to determining that lane-1 is associated with a merge-in ramp.

In some embodiments, each identifier of a lane segment stored in the map database 168 has a unique identifier so that the semantic rendering module 165 can uniquely identify each lane segment on a road and/or can query the map database using an identified of a lane segment to obtain additional information about the lane segment (e.g., whether it is an emergency lane or ramp or highway, or a speed limit of the lane segment, uphill/downhill grade, etc.).

In some embodiments, the semantic rendering module can assign an object or a vehicle with two identifiers in response to determining from the image that the object or vehicle is located on two lane segments of a lane (e.g., between two lanes or between a lane and a traffic intersection). Thus, the semantic rendering module can assign each object(s) and/or each vehicle(s) with a set of one or more identifiers, where each identifier identifies a lane segment on which an object or a vehicle is currently located or operating.

In some embodiments, a set of one or more identifiers associated with an object or a vehicle can also be associated with a corresponding one or more confidence scores that quantify one or more confidence levels of the object or the vehicle being associated with the one or more identifiers.

After the semantic rendering module determines identifiers of lane segments of each of the one or more lanes (as explained in operation 210), then the semantic rendering module can cause driving related operations based on the identifier associated with a lane segment on which the autonomous vehicle is operating or located. If the semantic rendering module obtains an identifier of a lane segment where the autonomous vehicle is operating, the semantic rendering module can query the map database using the identifier to obtain additional information about that lane segment such as speed limit associated with the lane segment, uphill/downhill grade of the lane segment, a description of a type of lane segment (e.g., whether the lane segment is a ramp or local road or highway or emergency lane), etc.

In a first example, if the semantic rendering module determines the speed limit associated with an identifier of lane segment (e.g., by querying the map database using the identifier), the semantic rendering module can send the speed limit information to the driving operation module (shown as 162 in FIG. 1) of the in-vehicle control computer. If the driving operation module obtains a current speed of the autonomous vehicle and determines that the current speed of the autonomous vehicle is greater than the speed limit of the lane segment, then the driving operation module can send instruction to one or more motors of a brake pedal or one or more actuators associated with the brakes to apply brakes to slow down the autonomous vehicle to operate at a speed less than or equal to the speed limit.

In a second example, if the semantic rendering module determines the downhill grade associated with an identifier of lane segment (e.g., by querying the map database using the identifier), then the semantic rendering module can send the downhill grade information of the identifier of the lane segment to the driving operation module. The driving operation module can receive the downhill grade information of the lane segment and can perform the following operations upon determining that the autonomous vehicle is operation in or is within a pre-determined distance of the location of the lane segment: send instruction to transmission of the autonomous vehicle to operate in a pre-determined gear based on a current speed of the autonomous vehicle and the downhill grade. In some embodiments, the driving operation module can receive the downhill grade information including speed limit of the lane segment and can perform the following operation upon determining that the autonomous vehicle is operation in or is within a pre-determined distance of the location of the lane segment and that a current speed of the autonomous vehicle is greater than a speed limit of the lane segment: send instructions to one or more motors of a brake pedal or actuators associates with the brakes to apply brakes to slow down the autonomous vehicle to operate at a speed less than or equal to a speed limit of the lane segment with the downhill grade.

After the semantic rendering module assigns identifiers of lane segments to one or more vehicles or one or more objects located around the autonomous vehicle (as explained in operation 210), then the semantic rendering module can send the identifier related information to the driving operation module. The driving operation module can cause driving related operations based on the identifier associated with a vehicle or an object. For example, if the semantic rendering module determines that an identifier of the vehicle is associated with an emergency lane or shoulder or breakdown lane, the semantic rendering module can send the identifier of the vehicle to the driving operation module. The driving operation module determines that the autonomous vehicle is operating on a first lane immediately adjacent to the emergency lane, then the driving operation module can send an instruction to a motor associated with a steering system of the autonomous vehicle that causes the autonomous vehicle to move into a second lane adjacent to the first lane and away from the emergency lane.

A first lane segment can occlude a second lane segment in some situations such as is shown in FIG. 3 where a portion of lanes 304, 306 moving uphill occludes another portion of the lanes 304, 306 located past the horizon. In FIG. 3, the first lane segment can include one or more triangles located before the horizon and the second lane segment includes the lane (indicated by dotted lines 314) past the horizon.

FIG. 4 shows an example flowchart of causing a vehicle to operate on a road in accordance with or in response to one or more characteristics of a lane segment on a lane on which the vehicle is operating. Operation 402 includes receiving, by a computer located in a vehicle, an image from a camera located on the vehicle while the vehicle is operating on a road, where the image includes a plurality of lanes of the road. Operation 404 includes, for each of the plurality of lanes: obtaining, from a map database stored in the computer, a set of values that describe locations of boundaries of a lane; dividing the lane into a plurality of polygons, where each polygon has vertices located at the boundaries of the lane, where the vertices are associated with location values from the set of values; rendering the plurality of polygons onto the image; and determining identifiers of lane segments of the lane, where the lane segments are imaginary and extend lengthwise along the lane, and where at least one lane segment of the lane is adjacent to at least one other lane segment of the lane. Operation 406 includes determining one or more characteristics of a lane segment on which the vehicle is operating based on an identifier of the lane segment. Operation 408 includes causing the vehicle to perform a driving related operation in response to the one or more characteristics of the lane segment on which the vehicle is operating.

In some embodiments, the method further comprises performing a first determination that a first polygon on the lane in the image has at least some region that overlaps with at least some other region of a second polygon on the lane in the image, where the first polygon includes a first set of sub-regions, and where the second polygon includes a second set of sub-regions; and obtaining, in response to the first determination, a third polygon as a combination of the first polygon and the second polygon by including in the third polygon a third set of sub-regions from the first set of sub-regions or the second set of sub-regions by comparing depth values of each overlapping sub-region from the first set of sub-regions and the second set of sub-regions. In some embodiments, each sub-region in the first set of sub-regions and the second set of sub-regions is associated with a depth value that describes a distance between a sub-region and a location of the vehicle. In some embodiments, the third polygon includes one or more non-overlapping regions from the first polygon and the second polygon. In some embodiments, for each overlapping sub-regions from the first set of sub-regions and the second set of sub-regions, the third set of sub-regions includes a first sub-region associated with a depth value that is closer to a location of the vehicle than that of a second sub-region that overlaps with the first sub-region.

In some embodiments, for each of the plurality of lanes, a plurality of pixels within the boundaries of the lane are associated with the identifiers of the lane segments of the lane. In some embodiments, a pixel value of a pixel from the plurality of pixels stores a second identifier of one lane segment that comprises the pixel. In some embodiments, for each of the plurality of lanes, the plurality of polygons includes a plurality of triangles that are located adjacent to each other and that describe an extent of the lane. In some embodiments, the set of values that describe the locations of the boundaries of the lane includes three-dimensional (3D) world coordinates for each of a plurality of point along the boundaries of the lane. In some embodiments, a plurality of pixels within the boundaries of the lane are associated with the 3D world coordinates of the lane.

In some embodiments, the one or more characteristics are determined by the processor configured to query the map database using the identifier of the lane segment, and the one or more characteristics includes a speed limit of the lane segment, an uphill grade of the lane segment, a downhill grade of the lane segment, or a description of a type of the lane segment. In some embodiments, the identifiers of the lane segments for each of the plurality of lanes are different from each other. In some embodiments, the one or more characteristics of the lane segment on which the vehicle is operating includes a speed limit of the lane segment, and the vehicle is caused to perform the driving related operation by the processor configured to: determine that a speed of the vehicle is greater than the speed limit of the lane segment; and send, to one or more motors of a brake pedal or one or more actuators associated with brakes of the vehicle, instruction that cause brakes to be applied.

In some embodiments, for each of the plurality of lanes, the identifiers of the lane segments of the lane is determined by: obtaining a location of the vehicle; and determining, from the map database stored in the computer, the identifiers of the lane segments of the lane located in front of or around the location of the vehicle. In some embodiments, the method further comprises: assigning, for each of the plurality of lanes, the identifiers of the lane segments of the lane to the lane segments on the lane in the image by determining in image locations of the lane segments relative to the location of the vehicle. In some embodiments, the method further comprises: assigning at least one identifier of a first lane segment to at least one vehicle in response to determining that the at least one vehicle is operating or located on the first lane segment.

In some embodiments, the causing the vehicle to perform the driving related operation includes sending an instruction to a motor associated with a steering system of the vehicle that causes the vehicle to move into another lane adjacent to the lane and away from an emergency lane in response to determining that: (1) the at least one identifier assigned to the at least one vehicle is associated with the emergency lane, and (2) the vehicle is operating on the lane immediately adjacent to the emergency lane. In some embodiments, the determining the identifiers of the lane segments of the lane located around the vehicle includes determining the identifiers of the lane segments of the lane located within a pre-determined distance from the location of the vehicle.

In this document the term “exemplary” is used to mean “an example of”′ and, unless otherwise stated, does not imply an ideal or a preferred embodiment. In this document, a computer or an in-vehicle control computer located in the vehicle may be one or more computers or one or more servers located in the vehicle.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of autonomous driving operation, comprising:
receiving, by a computer located in a vehicle, an image from a camera located on the vehicle while the vehicle is operating on a road, wherein the image includes a plurality of lanes of the road;
for each of the plurality of lanes:
obtaining, from a map database stored in the computer, a set of values that describe locations of boundaries of a lane;
dividing the lane into a plurality of polygons, wherein each polygon has vertices located at the boundaries of the lane, wherein the vertices are associated with location values from the set of values;
rendering the plurality of polygons onto the image; and
determining identifiers of lane segments of the lane, wherein the lane segments are imaginary and extend lengthwise along the lane, and wherein at least one lane segment of the lane is adjacent to at least one other lane segment of the lane;
determining one or more characteristics of a lane segment on which the vehicle is operating based on an identifier of the lane segment; and
causing the vehicle to perform a driving related operation in response to the one or more characteristics of the lane segment on which the vehicle is operating.

2. The method of claim 1, further comprising:
performing a first determination that a first polygon on the lane in the image has at least some region that overlaps with at least some other region of a second polygon on the lane in the image,
wherein the first polygon includes a first set of sub-regions, and
wherein the second polygon includes a second set of sub-regions; and
obtaining, in response to the first determination, a third polygon as a combination of the first polygon and the second polygon by including in the third polygon a third set of sub-regions from the first set of sub-regions or the second set of sub-regions by comparing depth values of each overlapping sub-region from the first set of sub-regions and the second set of sub-regions.

3. The method of claim 2, wherein each sub-region in the first set of sub-regions and the second set of sub-regions is associated with a depth value that describes a distance between a sub-region and a location of the vehicle.

4. The method of claim 2, wherein the third polygon includes one or more non-overlapping regions from the first polygon and the second polygon.

5. The method of claim 2, wherein, for each overlapping sub-regions from the first set of sub-regions and the second set of sub-regions, the third set of sub-regions includes a first sub-region associated with a depth value that is closer to a location of the vehicle than that of a second sub-region that overlaps with the first sub-region.

6. The method of claim 1, wherein, for each of the plurality of lanes, a plurality of pixels within the boundaries of the lane are associated with the identifiers of the lane segments of the lane.

7. The method of claim 6, wherein a pixel value of a pixel from the plurality of pixels stores a second identifier of one lane segment that comprises the pixel.

8. The method of claim 1, wherein, for each of the plurality of lanes, the plurality of polygons includes a plurality of triangles that are located adjacent to each other and that describe an extent of the lane.

9. The method of claim 1, wherein the set of values that describe the locations of the boundaries of the lane includes three-dimensional (3D) world coordinates for each of a plurality of point along the boundaries of the lane.

10. The method of claim 9, wherein a plurality of pixels within the boundaries of the lane are associated with the 3D world coordinates of the lane.

11. A system for autonomous vehicle operation, the system comprising a computer in a vehicle, the computer including a processor configured to:
receive an image from a camera located on the vehicle while the vehicle is operating on a road, wherein the image includes a plurality of lanes of the road;
for each of the plurality of lanes:
obtain, from a map database stored in the computer, a set of values that describe locations of boundaries of a lane;
divide the lane into a plurality of polygons, wherein each polygon has vertices located at the boundaries of the lane, wherein the vertices are associated with location values from the set of values;
render the plurality of polygons onto the image; and
determine identifiers of lane segments of the lane, wherein the lane segments are imaginary and extend lengthwise along the lane, and wherein at least one lane segment of the lane is adjacent to at least one other lane segment of the lane;
determine one or more characteristics of a lane segment on which the vehicle is operating based on an identifier of the lane segment; and
cause the vehicle to perform a driving related operation in response to the one or more characteristics of the lane segment on which the vehicle is operating.

12. The system of claim 11,
wherein the one or more characteristics are determined by the processor configured to query the map database using the identifier of the lane segment, and
wherein the one or more characteristics includes a speed limit of the lane segment, an uphill grade of the lane segment, a downhill grade of the lane segment, or a description of a type of the lane segment.

13. The system of claim 11, wherein the identifiers of the lane segments for each of the plurality of lanes are different from each other.

14. The system of claim 11,
wherein the one or more characteristics of the lane segment on which the vehicle is operating includes a speed limit of the lane segment, and
wherein the vehicle is caused to perform the driving related operation by the processor configured to:
determine that a speed of the vehicle is greater than the speed limit of the lane segment; and
send, to one or more motors of a brake pedal or one or more actuators associated with brakes of the vehicle, instruction that cause brakes to be applied.

15. A non-transitory computer readable program storage medium having code stored thereon, the code, when executed by a processor, causing the processor to implement a method comprising:
receiving, by a computer located in a vehicle, an image from a camera located on the vehicle while the vehicle is operating on a road, wherein the image includes a plurality of lanes of the road;
for each of the plurality of lanes:
obtaining, from a map database stored in the computer, a set of values that describe locations of boundaries of a lane;
dividing the lane into a plurality of polygons, wherein each polygon has vertices located at the boundaries of the lane, wherein the vertices are associated with location values from the set of values;
rendering the plurality of polygons onto the image; and
determining identifiers of lane segments of the lane, wherein the lane segments are imaginary and extend lengthwise along the lane, and wherein at least one lane segment of the lane is adjacent to at least one other lane segment of the lane;
determining one or more characteristics of a lane segment on which the vehicle is operating based on an identifier of the lane segment; and
causing the vehicle to perform a driving related operation in response to the one or more characteristics of the lane segment on which the vehicle is operating.

16. The non-transitory computer readable program storage medium of claim 15, wherein, for each of the plurality of lanes, the identifiers of the lane segments of the lane is determined by:
obtaining a location of the vehicle; and
determining, from the map database stored in the computer, the identifiers of the lane segments of the lane located in front of or around the location of the vehicle.

17. The non-transitory computer readable program storage medium of claim 16, wherein the method further comprises:
assigning, for each of the plurality of lanes, the identifiers of the lane segments of the lane to the lane segments on the lane in the image by determining in image locations of the lane segments relative to the location of the vehicle.

18. The non-transitory computer readable program storage medium of claim 17, wherein the method further comprises:
assigning at least one identifier of a first lane segment to at least one vehicle in response to determining that the at least one vehicle is operating or located on the first lane segment.

19. The non-transitory computer readable program storage medium of claim 18,
wherein the causing the vehicle to perform the driving related operation includes sending an instruction to a motor associated with a steering system of the vehicle that causes the vehicle to move into another lane adjacent to the lane and away from an emergency lane in response to determining that:
(1) the at least one identifier assigned to the at least one vehicle is associated with the emergency lane, and
(2) the vehicle is operating on the lane immediately adjacent to the emergency lane.

20. The non-transitory computer readable program storage medium of claim 16, wherein the determining the identifiers of the lane segments of the lane located around the vehicle includes determining the identifiers of the lane segments of the lane located within a pre-determined distance from the location of the vehicle.
